(19) United States
(12) Patent Application Publication
(10) Pub. No.: US 2017/0111942 A1
(43) Pub. Date: Apr. 20, 2017

(54) MACHINE TYPE COMMUNICATION METHOD AND MTC DEVICE USING SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: CHI-HAO CHANG, New Taipei (TW)

(21) Appl. No.: 14/886,283

(22) Filed: Oct. 19, 2015

(51) Int. Cl. H04W 76/02; H04W 8/00; H04W 4/00

(52) U.S. Cl. CPC H04W 76/023; H04W 4/005; H04W 8/005

(57) ABSTRACT

A MTC method for a MTC device is provided. The method includes: establishing a connection with a base station which is coupled with a MTC server; uploading device information of the MTC device to the MTC server through the base station; receiving a first notification that the MTC device is designated as a bridge MTC device from the MTC server; receiving a MTC device list when need to upload data to the MTC server; transmitting upload request, the MTC device list and data of the MTC device to be uploaded to a first MTC device defined in the MTC device list; receiving data from a last MTC device defined in the MTC device list, wherein the data from the last MTC device includes data of all MTC devices defined in the MTC list to be uploaded to the MTC server; and uploading the received data to the MTC server.

### FIELD

The subject matter herein generally relates to a wireless communication system and communication method thereof and, in particular, to a wireless communication system and method for Machine Type Communication (MTC).

### BACKGROUND

Universal Mobile Telecommunications System (UMTS) is the third generation wireless communication system based on Global System for Mobile communications (GSM) and General Packet Radio Services (GPRS) and uses Wideband Code Division Multiple Access (WCDMA). The 3rd Generation Partnership Project (3GPP) as the UMTS standardization organization has proposed Evolved Packet System (EPS) such as Long Term Evolution (LTE). The LTE is a technology for implementing high speed packet-based communication. The 3GPP also has proposed MTC (also called Machine-to-Machine communication) for data communication between entities that do not necessarily need human interaction, and the most typical example thereof is the communication between a terminal and an application server, wherein the terminal is called an MTC device and the application server is called an MTC Server.

### BRIEF DESCRIPTION OF THE DRAWINGS

Implementations of the present technology will now be described, by way of example only, with reference to the attached figures.

FIG. 1 is a diagrammatic view of an exemplary embodiment of work environment of a MTC device.

FIG. 2 is a block diagram of an exemplary embodiment of a MTC device.

FIG. 3 is a flow chart of an exemplary embodiment of a MTC method for registration of a MTC device to a MTC server.

FIG. 4 is a flow chart of another exemplary embodiment of a MTC method for a MTC device which is designated as a bridge MTC device.

FIG. 5 is a flow chart of another exemplary embodiment of a MTC method for a MTC device which is not designated as a bridge MTC device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

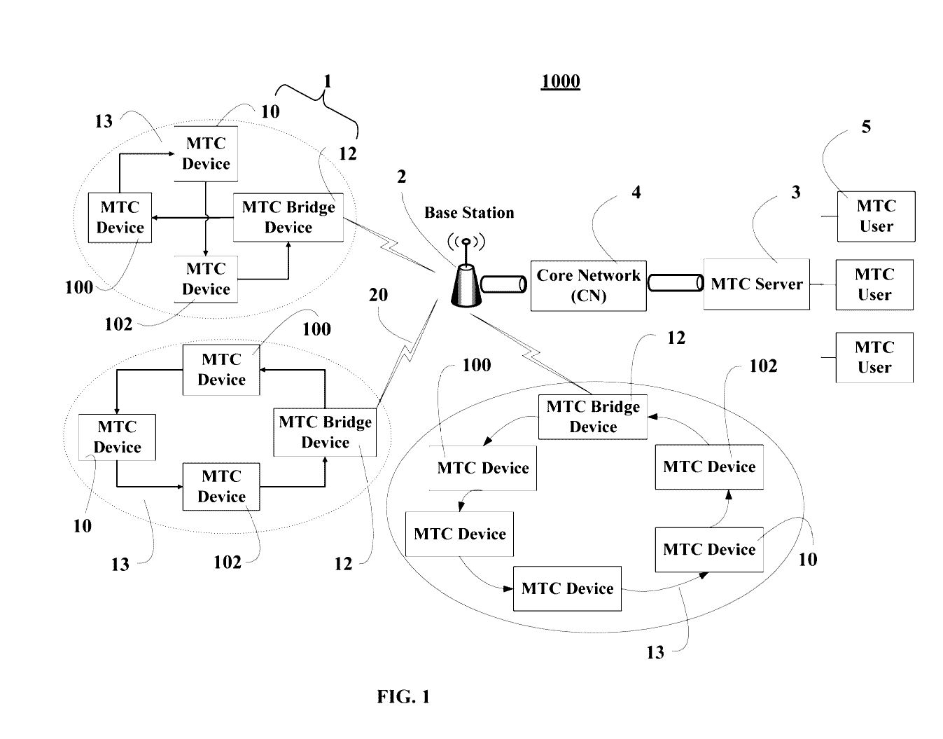

FIG. 1 illustrates a diagrammatic view of an exemplary embodiment of a communication system including at least one Machine Type Communication (MTC) device 1. In the exemplary embodiment, the communication system 1000 can include a plurality of MTC devices 1, a base station 2, a MTC server 3, a Core Network (CN) 4, and at least one MTC user. The plurality of MTC devices 1 can be interconnected with each other. The plurality of MTC devices 1 can be connected to the base station 2 through an air interface 20. The MTC server 3 can be connected to the base station 2 through the CN 4 and can be connected to at least one MTC user 5.

Each of the MTC devices 1 can be any type of device configured to operate and/or communicate in a wireless environment. By way of example, the MTC device 1 can be configured to transmit and/or receive wireless signals and can include user equipment (UE), a mobile station, a fixed or mobile subscriber unit, a pager, a cellular telephone, a Personal Digital Assistant (PDA), a smartphone, a laptop, a netbook, a personal computer, a wireless sensor, consumer electronics, and the like. The plurality of MTC devices 1 can be interconnected with each other. The plurality of MTC devices 1 can be classified into one or more groups. In at least one embodiment, a MTC group can be defined based on location or shared features of the MTC devices. For example, MTC devices located in the same area may be grouped into an MTC group; MTC devices that use a common application may be classified as a group. Each group of MTC devices can have a bridge MTC device 12 serving as a MTC gateway or Master MTC to communicate with the base station 2. The bridge MTC device 12 can communicate with the other MTC devices 10 to collect data to be transmitted to the MTC server 3 from the other MTC devices 10 and then transmit the collected data to the MTC server 3 through the base station 2. The bridge MTC device 12 and the other MTC devices 10 can interconnected in sequence to form a virtual train 13. In the virtual train 13, the bridge MTC device 12 can be connected between the first MTC device 100 and the last MTC device 102, and the other MTC devices 10 except for the first device 100 and last MTC device 102 can be connected in sequence between the first MTC device 100 and the last MTC device 102.

The base stations 2 can be any type of device configured to wirelessly interface with the at least one of the MTC devices to facilitate access to one or more communication networks, such as the core network 4. By way of example, the base stations 2 may be a base transceiver station (BTS), a Node-B, an eNode B, a Home Node B, a Home eNode B, a site controller, an access point (AP), a wireless router, and the like.

The air interface 20 can be any suitable wireless communication link, for example, radio frequency (RF), microwave, infrared (IR), ultraviolet (UV), visible light, etc. The air interface 20 may be established using any suitable radio access technology (RAT).

The MTC server 3 can be a Machine-to-Machine (M2M) Application Server (AS).

The CN 4 can be any type of network configured to provide voice, data, applications, and/or voice over internet protocol (VoIP) services to one or more of the MTC devices 1.

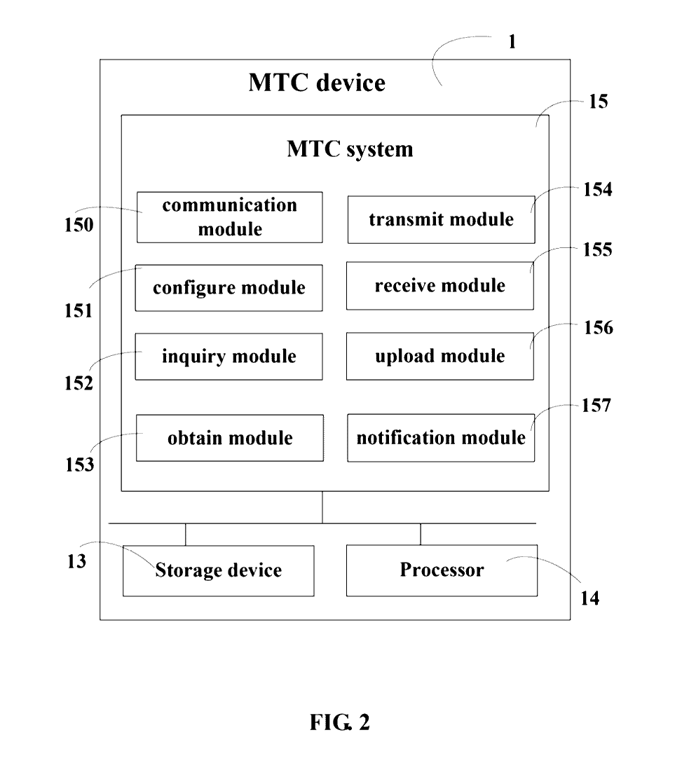

FIG. 2 illustrates a block diagram of an exemplary embodiment of a MTC device 1.

The MTC device 1 can include, but is not limited to, a storage device 13 and a processor 14. The processor 14 can be a central processing unit (CPU), a microprocessor, or other data processor chip that performs functions of the MTC device 1. The storage unit 13 can be an internal storage unit of the MTC device 1, for example, a hard disk or memory, or a pluggable memory, for example, Smart Media Card, Secure Digital Card, Flash Card. In at least one embodiment, the storage unit 13 can include two or more storage devices such that one storage device is an internal storage unit and the other storage device is a removable memory.

A MTC system 15 can include computerized instructions in the form of one or more programs that can be executed by the processor 14. In the embodiment, the MTC system 15 can be integrated in the processor 14. In at least one embodiment, the MTC system 15 can be independent from the processor 14 and can be stored in the storage unit 13 and coupled to the processor 14. The system 15 can include one or more modules, for example, a communication module 150, a configuration module 151, an inquiry module 152, an obtaining module 153, a transmit module 154, a receiving module 155, an upload module 156, and a notification module 157. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The communication module 150 can be configured to communicate with the base station via the air interface 20.

The configuration module 151 can be configured to set the MTC device 1 to be a bridge MTC device. In at least one embodiment, each MTC device has MTC device information thereof. The MTC device information can include, but is not limited to, identification number, product type, location, states, a mark indicating whether the MTC device is designated as a bridge MTC device. The state of the MTC device can include a valid state in which the MTC device can be accessed by other devices and can receive information from other devices, and an invalid state in which the MTC device cannot receive information from and/or transmit information to other devices. When the MTC device 1 receives a notification that the MTC device is designated as a bridge MTC device, the configuration module 151 can modify the mark of the MTC device to indicate that the MTC device is a bridge MTC device. The configuration module 151 further can be configured to set a state of a MTC device which is cannot be accessed to be invalid.

The inquiry module 152 can be configured to request a latest MTC device list from the MTC server 3.

The obtaining module 153 can be configured to obtain the latest MTC device list from the MTC server 3. The transmit module 154 can be configured to transmit upload request and the latest MTC device list and data to be uploaded to a second MTC device which is in a same group with the MTC device.

The receiving module 155 can be configured to receive data to be uploaded from a MTC device. In the exemplary embodiment, the MTC devices in a same group can be interconnected in sequence to form a communication circle: the bridge MTC device can communicate with a first MTC device and a last MTC device (as illustrated in FIG. 1), and other MTC devices are connected between the first MTC device and the last MTC device in sequence. If the MTC device is a bridge MTC device, the receiving module 155 can receive data from the last MTC device. If the MTC device is not a bridge MTC device and not the last MTC device, the receiving module 15 can receive data from a previous MTC device and add data that the MTC device wants to upload to the MTC server 3 to the received data to form an updated data and then transmit the updated data to a next MTC device. If the MTC device is the last MTC device, the receiving module 15 can receive data from a previous MTC device and add data that the MTC device wants to upload to the MTC server 3 to the received data to form an updated data and then transmit the updated data to the bridge MTC device 12.

The upload module 156 can be configured to upload the data received from the last MTC device to the MTC server 3 through the base station 2.

The notification module 157 can be configured to receive a notification that designates a designated MTC device to be a bridge MTC device from the MTC server 3 and transmit the notification to the designated MTC device.

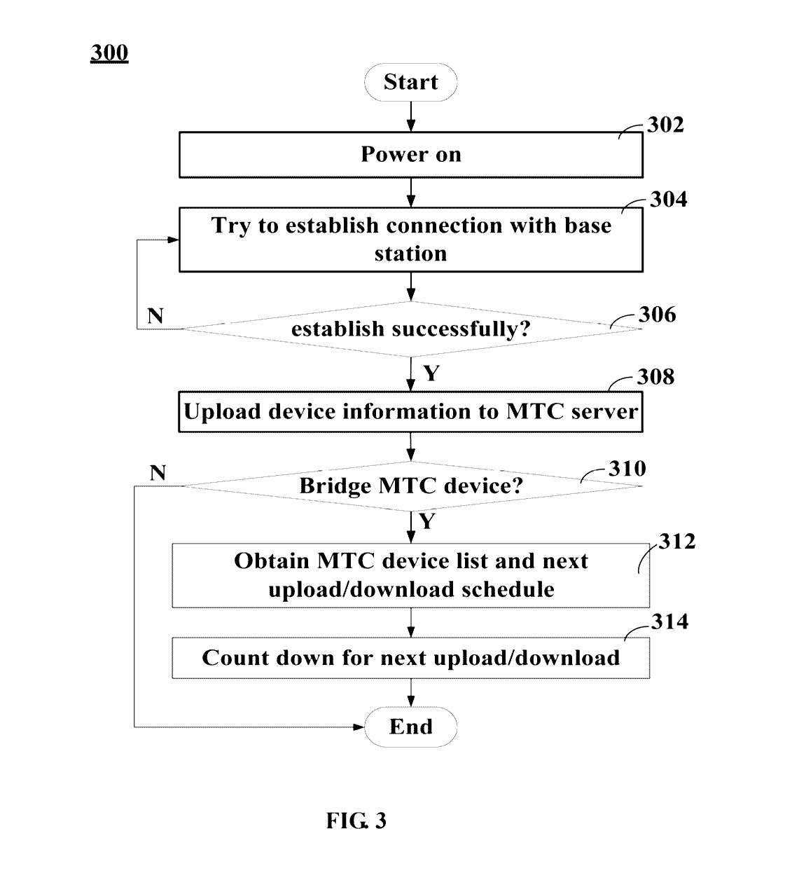

FIG. 3 illustrates a flowchart of an exemplary embodiment of a data sharing method 300 performed by an MTC device serving a seed. The example method 300 is provided by way of example, as there are a variety of ways to carry out the method. The method 300 described below can be carried out using the configurations illustrated in FIGS. 1-2, for example, and various elements of the figure is referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary method 300 can begin at block 302.

At block 302, the MTC device is powered on. In at least one embodiment, the MTC device can include a button which can be pressed to power on the MTC device. Alternatively, in at least one embodiment, the MTC device can be powered on by a remote controller.

At block 304, the MTC device tries to establish a connection with a base station. In at least one embodiment, the MTC device can firstly search for available networks, for example, air interface 20 illustrated in FIG. 1, and then try to establish a connection with the base station through an available network. In at least one embodiment, the MTC device can search for available base stations through the available network and then try to establish a connection with a base station which is closest to the MTC device.

At block 306, the MTC device determines whether the connection with the base station is established successfully. If the connection is established successfully, the process goes to block 308, otherwise, the process goes back to block 304.

At block 308, the MTC device uploads device information thereof to a MTC server through the base station. In at least one embodiment, the device information of the MTC device can include, but is not limited to, identification number, product type, location, states, a mark indicating whether the MTC device is designated as a bridge MTC device. The state of the MTC device can include a valid state in which the MTC device can be accessed by other devices and can receive information from other devices, and an invalid state in which the MTC device cannot receive information from and/or transmit information to other devices.

At block 310, the MTC device determines whether the MTC device is designated as a bridge MTC device. The MTC device can be designated as a bridge MTC device based on user selection or predefined algorithm, for example, selecting a MTC device with highest processing capability as a bridge MTC device. If the MTC device is designated as a bridge MTC device, the mark of the MTC device can indicates that the MTC device is designated as a bridge MTC device. That is, the MTC device can determine whether the MTC device is designated as a bridge MTC device based on the mark of the MTC device. If the MTC device is designated as a bridge MTC device, the process goes to block 312, otherwise the process goes to an end.

At block 312, the MTC device obtains a MTC device list from the MTC server. The MTC device list can include a plurality of MTC devices which can be coupled to the MTC server. In the exemplary embodiment, the MTC device obtains an upload/download schedule from the MTC server. The schedule can define time for data to be transmitted between the MTC server and the MTC device.

At block 314, the MTC device counts down to wait for data transmission between the MTC server and the MTC device defined in the schedule. For example, if current time is 2015.09.15, 8:00 am, the scheduled time for data transmission between the MTC server and the MTC device in the schedule is 2015.09.30, 8:00 am, the MTC device wait to start transmission until it is the scheduled time.

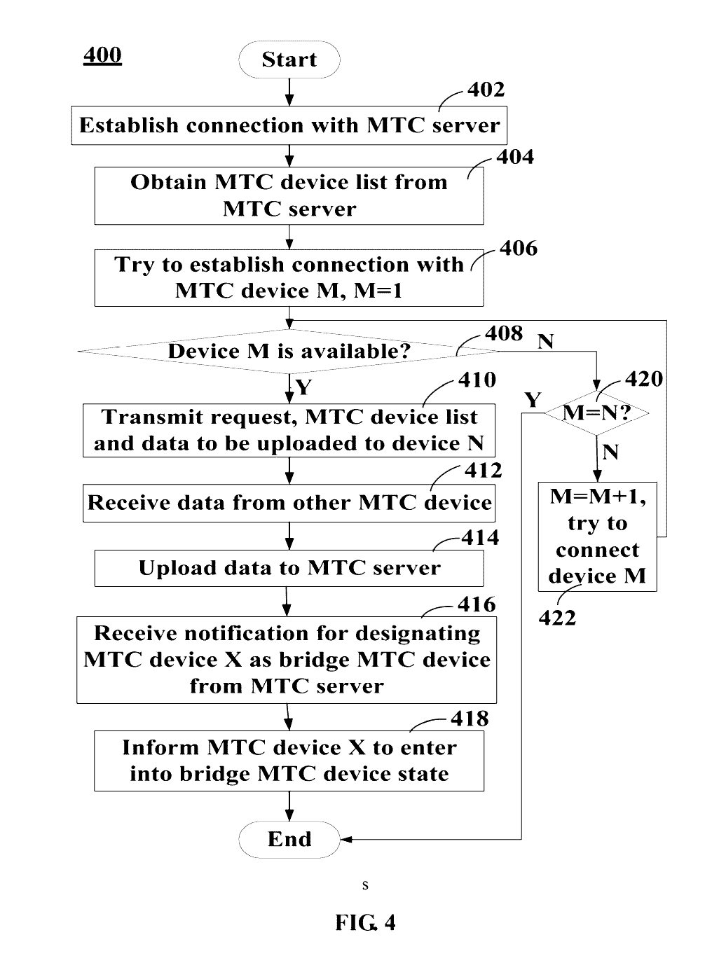

FIG. 4 illustrates a flowchart of an exemplary embodiment of a MTC method 400 performed by a MTC device serving a bridge MTC device. The example method 400 is provided by way of example, as there are a variety of ways to carry out the method. The method 400 described below can be carried out using the configurations illustrated in FIGS. 1-2, for example, and various elements of the figure is referenced in explaining example method 400. Each block shown in FIG. 4 represents one or more processes, methods or subroutines, carried out in the exemplary method 400. Furthermore, the illustrated order of blocks is by example only and the order of the blocks can change according to the present disclosure. Additional blocks may be added or fewer blocks may be utilized, without departing from this disclosure. The exemplary method 400 can begin at block 402.

At block 402, the MTC device establishes a connection with a MTC server when uploading data to the MTC server is required. For example, when it's up to a specific time defined in a preset schedule for uploading data to the MTC server, the process goes to block 402.

At block 404, the MTC device obtains a latest MTC device list from MTC server. The MTC device list defines a plurality of MTC device numbered from 1 to N.

At block 406, the MTC device tries to establish a connection with a MTC device M, M=1.

At block 408, the MTC device determines whether the connection with the MTC device M can be established successfully. If the connection with the MTC device M can be established, the process goes to block 410, otherwise, the process goes to block 420. In at least one embodiment, if the connection with the MTC device M cannot be established, the MTC device M can be deemed as invalid, for example, the MTC device is out of service, or the MTC device is disconnected from any available networks. In at least one embodiment, the MTC device list can include states of each MTC device listed in the MTC list. The states of each MTC device can include a valid state in which the MTC device can transmit data to and/or receive data from other devices, and an invalid state in which the MTC device cannot transmit data to and/or receive data from other devices. If the connection with the MTC device M cannot be established, the MTC device can label the MTC device M to be invalid in the device list.

At block 410, the MTC device transmits upload request, the MTC device list and data of the MTC device to be uploaded to the MTC device M.

At block 412, the MTC device receives data from other MTC device, for example the MTC device N which is the last MTC device defined in the MTC device list. The data received from other MTC device can include all data to be uploaded to the MTC server from all MTC device in a valid state defined in the MTC device list.

At block 414, the MTC device uploads the received data from the MTC device N to the MTC server. That is, the data from all MTC devices in a valid state recorded in the device list is transmitted to the MTC server.

If the MTC server wants to designate another MTC device X (1<=X<=N) to be the bridge MTC device, the MTC server can transmit a notification to the MTC device to inform the MTC device that the MTC device X will replace the current bridge MTC device.

At block 416, the MTC device receives the notification for designating the MTC device X as the bridge MTC device from the MTC server.

At block 418, the MTC device transmits the notification to the MTC device X to inform the MTC device X to enter into a bridge MTC device state. In at least one embodiment, the MTC device X can have device information which can include a mark indicating whether the MTC device is a bridge MTC device.

At block 420, the MTC device determines whether M equals to N. If M is not equals to N, the process goes to block 422, otherwise the process goes to an end.

At block 422, the MTC device assigns M to be M+1, and tries to establish a connection with the MTC device M. Then, the process goes back to block 408.

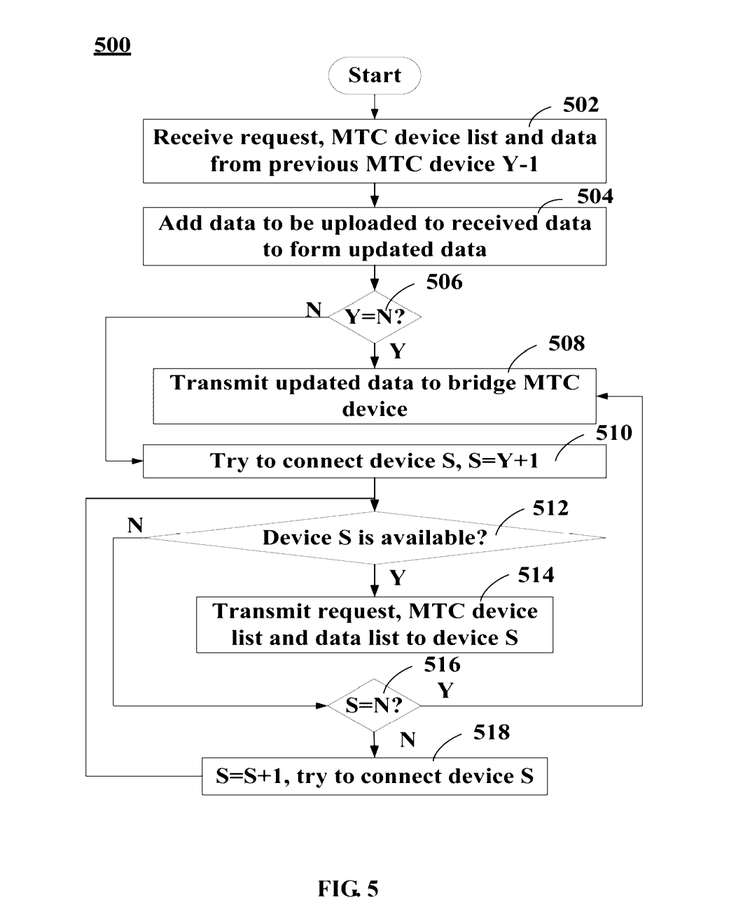

FIG. 5 illustrates a flowchart of an exemplary embodiment of a MTC method 500 performed by a MTC device Y which is not a bridge MTC device. The example method 500 is provided by way of example, as there are a variety of ways to carry out the method. The method 500 described below can be carried out using the configurations illustrated in FIGS. 1-2, for example, and various elements of the figure is referenced in explaining example method 500. Each block shown in FIG. 5 represents one or more processes, methods or subroutines, carried out in the exemplary method 500. Furthermore, the illustrated order of blocks is by example only and the order of the blocks can change according to the present disclosure. Additional blocks may be added or fewer blocks may be utilized, without departing from this disclosure. The exemplary method 500 can begin at block 502.

At block 502, the MTC device Y receives upload request, a MTC device list and data from a previous MTC device Y−1. The bridge MTC device can be deemed as a MTC device numbered “0”. That is, if Y=1, the MTC device Y receives the upload request, and a MTC device list, in at least one embodiment, the MTC device Y can receive data from the bridge MTC device. The data from the bridge MTC device is that the bridge MTC device wants to transmit to the MTC server. The MTC device list defines a plurality of MTC devices numbered from 1 to N. Y is equals to or greater than 1, and equals to or less than N. The plurality of MTC devices can be interconnected in the sequence along which the MTC devices are numbered so as to form a virtual train 13 as illustrated in FIG. 1.

At block 504, the MTC device Y adds data of the MTC device Y to be uploaded to the received data to form an updated data. That is, the updated data can include data from MTC devices numbered from 1 to Y. It should be understood, if the received data include the data from the bridge MTC device, the updated data can include data from MTC devices numbered from 0 to Y.

At block 506, the MTC device Y determines whether Y equals to N. If Y equals N, the process goes to block 508, otherwise, the process goes go block 510. In the illustrated embodiment, if Y equals N, the MTC device Y can be deemed as the last MTC device listed in the device list.

At block 508, the MTC device Y transmits the updated data to the bridge MTC device. That is, the data from all MTC devices listed in the MTC device list have been transmitted to the bridge MTC device.

At block 510, the MTC device Y tries to connect a MTC device S, S=Y+1.

At block 512, the MTC device determines whether a connection between the MTC device Y and the MTC device S can be established successfully. If the connection between the MTC device and the MTC device S can be established successfully, the process goes to block 514, otherwise the process goes to block 516. In at least one embodiment, if the connection with the MTC device S cannot be established, the MTC device M can be deemed as invalid, for example, the MTC device S is out of service or the MTC device S is disconnected from any available networks.

At block 514, the MTC device Y transmits the upload request, the MTC device list and the updated data to the MTC device S.

At block 516, the MTC device Y determines whether S equals to N. If S equals to N, the process goes back to block 508, otherwise, the process goes to block 518.

At block 518, the MTC device Y assigns S to be S+1 and then tries to connect the MTC device S. Then, the process goes back to block 512.

The embodiments illustrate only uploading data to the MTC server. However, it can be understood that downloading data from the MTC server to the MTC devices also can using similar method. For example, when downloading data from the MTC server to the MTC devices, the bridge MTC device can first download all data from the MTC server and then transmit in sequence through the virtual train illustrated in FIG. 1 to other MTC devices.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A Machine Type Communication (MTC) method, comprising:
establishing, at a MTC device, a connection with a base station which is coupled with a MTC server;
uploading, at the MTC device, device information of the MTC device to the MTC server through the base station;
receiving, at the MTC device, a first notification that the MTC device is designated as a bridge MTC device from the MTC server;
receiving, at the MTC device, a MTC device list when need to upload data to the MTC server, wherein the MTC device defines a plurality of MTC devices numbered from 1 to N;
transmitting, from the MTC device, upload request, the MTC device list to a first MTC device numbered 1 defined in the MTC device list;
receiving, at the MTC device, data from a last MTC device defined in the MTC device list, wherein the data from the last MTC device includes data of all MTC devices defined in the MTC list to be uploaded to the MTC server; and
uploading, from the MTC device, the received data to the MTC server.

2. The method according to claim 1, further comprising:
determining, at the MTC device, whether the first MTC device can be connected successfully;
searching, at the MTC device, an available MTC device defined in the MTC device list in the same order with the MTC device numbered in the MTC device list, if the first MTC device cannot be connected successfully; and
transmitting, from the MTC device, the upload request, the MTC device list and data of the MTC device to be uploaded to the available MTC device.

3. The method according to claim 1, further comprising:
Upon being designated as the bridge MTC device, receiving, at the MTC device, an upload schedule from the MTC server, wherein the upload schedule defines a specific time for the MTC device to upload data to the MTC server and the specific time is the time when need to upload data to the MTC server.

4. The method according to claim 1, further comprising:
receiving, at the MTC device, a second notification that designates a second MTC device as the bridge MTC device from the MTC server; and
transmitting, from the MTC device, the second notification to the second MTC device.

5. The method according to claim 1, further comprising:
receiving, at the MTC device, upload request, the MTC device list, and data from a previous MTC device, upon a condition that the MTC device is not designated as the bridge MTC device;
adding, at the MTC device, data of the MTC device to be uploaded to the server to the received data to form updated data;
transmitting, at the MTC device, the updated data to a next MTC device, upon a condition that the MTC device is not the last MTC device; and
transmitting, at the MTC device, the updated data to the bridge MTC device, upon a condition that the MTC device is the last MTC device.

6. The method according to claim 5, further comprising:
determining, at the MTC device, whether the next MTC device can be connected successfully;
searching, at the MTC device, an available next MTC device defined in the MTC device list in the same order with the MTC device numbered in the MTC device list, if the next MTC device cannot be connected successfully; and
transmitting, from the MTC device, the upload request, the MTC device list and the updated data to be uploaded to the available next MTC device.

7. The method according to claim 1, further comprising:
transmitting, from the MTC device, the updated data to be uploaded to the bridge MTC device upon a condition that no available next MTC device exists.

8. The method according to claim 1, further comprising:
transmitting, at the MTC device, the data to be uploaded to the server to the first MTC device.

9. The method according to claim 1, further comprising:
adding, at the MTC device, the data to be uploaded to the server to the received data to form updated data; and
uploading, at the MTC device, the updated data to the MTC server.

10. An MTC device, comprising:
a storage unit configured to store instructions; and
a processor configured to execute instructions to cause the processor to:
establish a connection with a base station which is coupled with a MTC server;
upload device information of the MTC device to the MTC server through the base station;
receive a first notification that the MTC device is designated as a bridge MTC device from the MTC server;
receive a MTC device list when need to upload data to the MTC server, wherein the MTC device defines a plurality of MTC devices numbered from 1 to N;
transmit upload request, the MTC device list and data of the MTC device to be uploaded to a first MTC device numbered 1 defined in the MTC device list;
receive data from a last MTC device defined in the MTC device list, wherein the data from the last MTC device includes data of all MTC devices defined in the MTC list to be uploaded to the MTC server; and
upload the received data to the MTC server.

11. The MTC device according to claim 10, wherein the instructions further cause the processor to:
determine whether the first MTC device can be connected successfully;
search an available MTC device defined in the MTC device list in the same order with the MTC device numbered in the MTC device list, if the first MTC device cannot be connected successfully; and
transmit the upload request, the MTC device list and data of the MTC device to be uploaded to the available MTC device.

12. The MTC device according to claim 10, wherein the instructions further cause the processor to:
Upon being designated as the bridge MTC device, receiving, at the MTC device, an upload schedule from the MTC server, wherein the upload schedule defines a specific time for the MTC device to upload data to the MTC server and the specific time is the time when need to upload data to the MTC server.

13. The MTC device according to claim 10, wherein the instructions further cause the processor to:
receive a second notification that designates a second MTC device as the bridge MTC device from the MTC server; and
transmit the second notification to the second MTC device.

14. The MTC device according to claim 10, wherein the instructions further cause the processor to:
receive upload request, the MTC device list, and data from a previous MTC device, upon a condition that the MTC device is not designated as the bridge MTC device;
add data of the MTC device to be uploaded to the server to the received data to form updated data;
transmit the updated data to a next MTC device, upon a condition that the MTC device is not the last MTC device; and
transmit the updated data to the bridge MTC device, upon a condition that the MTC device is the last MTC device.

15. The MTC device according to claim 10, wherein the instructions further cause the processor to:
determine whether the next MTC device can be connected successfully;
search an available next MTC device defined in the MTC device list in the same order with the MTC device numbered in the MTC device list, if the next MTC device cannot be connected successfully; and
transmit the upload request, the MTC device list and the updated data to be uploaded to the available next MTC device.

16. The MTC device according to claim 15, wherein the instructions further cause the processor to:
transmit the updated data to be uploaded to the bridge MTC device upon a condition that no available next MTC device exists.

17. The MTC device according to claim 10, wherein the instructions further cause the processor to:
transmit the data to be uploaded to the server to the first MTC device.

18. The MTC device according to claim 10, wherein the instructions further cause the processor to:
add the data to be uploaded to the server to the received data to form updated data; and
upload the updated data to the MTC server.
